(19) United States
(12) Patent Application Publication
(10) Pub. No.: US 2011/0113357 A1
(43) Pub. Date: May 12, 2011

(54) MANIPULATING RESULTS OF A MEDIA ARCHIVE SEARCH

(75) Inventors: Marcel C. Rosu, Hawthorne, NY (US); Nathaniel Ayewah, Hyattsville, ND (US)

(73) Assignee: INTERNATIONAL BUSINESS MACHINES CORPORATION, Armonk, NY (US)

(21) Appl. No.: 12/616,903

(22) Filed: Nov. 12, 2009

(51) Int. Cl. G06F 3/048; G06F 17/30

(52) U.S. Cl. 715/764; 707/722; 707/E17.014

(57) ABSTRACT

Systems and method for manipulating results of a media archive search. Exemplary embodiments include a method for manipulating the results of a media archive search, the method including sending search terms related to one or more archive items in the media archive, receiving search results from the media archive, displaying the search results on a display, sending manipulation commands, performing manipulation operations based on the manipulation commands, displaying modified search results on the screen based on the manipulation operations and identifying attributes for each of the one or more archive items.

### BACKGROUND

The present invention relates to searching media archives, and more specifically, to a dynamic interface for manipulating media archive search results.

Audio and video recordings, such as conference call recordings, podcasts, videos, and recordings of presentations or lectures, are increasingly used for information dissemination and storage. Searching media archives is a more difficult task than searching text archives because searching media archives relies mainly on indexing and searching the voice-to-text synchronized translations of the sound tracks of the archive recordings, which are rarely accurate. The precision of the transcription of the recordings can vary widely with the quality of the recording and with the speaker characteristics. As such, media transcripts may include several errors to the text such as misspellings or that the words were transcribed incorrectly because the recognition of the word is context-dependent. As a consequence, the result of a search can include many more irrelevant elements than text search would include on the archive of manual transcripts, (i.e. precision and recall can be lower as compared to a non-transcript text search). Furthermore, once the search completes, it is more difficult for the user to determine the relevance of the results returned by a media archive search than by a text archive search, as the visualization of the latter include short text fragments highlighting the search terms in context. Enhancing the results of a media archive search with text fragments surrounding search terms from the transcript is possible but difficult because automatic transcripts: include many errors, especially for short, common words (which are rarely used in search but are crucial when trying to understand the meaning of a sentence/short fragment); and are rarely capable of segmenting the word stream into sentences, or to identify punctuation signs, new paragraphs or speakers. Furthermore, the transcription is of limited value as words not included in the transcriber's vocabulary are never present in the index and cannot be used for searching. Therefore, transcription accuracy affects the ranking of search results, which takes into account the frequency of the search terms in each of the recordings that satisfy the Boolean query.

Existing systems identify the location of the search terms in the stream to quickly allow users to gather context by listening to the recording segment surrounding the search term position. Such user interfaces are static and they do not allow users to properly react to what they have listen to, such as updating the relevance of the “just listened to” recoding(s). Identifying the relevant information among the results of a media search is more difficult than for the results of document searches as well. A quick look at a document is typically enough to determine if it includes the information needed. The document formatting elements, such as paragraphs or fonts, play an important role in helping us find the relevant sentences, phrases, or data (tables, graphs, enumerations, etc.). Unfortunately, such visual cues cannot be generated accurately using existing voice-to-text computer programs. Typically, in a media search, the relevant information is retrieved by playing variable length segments of the media recordings retrieved by the Boolean search. This process is lengthy, it may complete in more than one session and the user may be interrupted by other events before it completes a search task. To speed-up the identification task, the system should precisely identify the relevant segments for the user and it should allow the user to edit the ranked set as desired during the identification process, with the goal of maximizing the user productivity across sessions, minimizing the negative impact of interruptions, or for saving a customization of the search results for later usage or sharing.

Therefore, there is a need for the user to easily manipulate the search results, save the outcome of this effort, and possibly share it with other users of the system.

### SUMMARY

Exemplary embodiments include a method for manipulating the results of a media archive search, the method including sending search terms related to one or more archive items in the media archive, receiving search results from the media archive, displaying the search results on a display, sending manipulation commands, performing manipulation operations based on the manipulation commands, displaying modified search results on the screen based on the manipulation operations and identifying attributes for each of the one or more archive items.

Further exemplary embodiments include a method in a computer system having a graphical user interface including a display and a selection device, the method for manipulating the results of a media archive search on the display, and including retrieving a set of items in a media search, displaying the set of items on the display, receiving a manipulation selection command indicative of the selection device pointing at a selected items of the media search and in response to the manipulation selection command, performing a manipulation action at the selected items of the media search.

Additional embodiments include a computer program product for manipulating the results of a media archive search, the computer program product including instructions for causing a computer to implement a method, the method including sending search terms related to one or more media archive items in the media archive, receiving search results from the media archive, displaying the search results on the display, sending manipulation commands, performing manipulation operations based on the manipulation commands, displaying modified search results on the screen based on the manipulation operations and identifying attributes for each of the one or more archive items.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a system for manipulating the results of searching media archives;

FIG. 2 illustrates a screenshot of an example of a browser-based user interface (UI) for manipulating the results of speech archive searches.

FIG. 3 illustrates a screenshot of another example of a browser-based user interface for manipulating the results of speech archive searches.

FIG. 4 illustrates a screenshot of another example of a browser-based user interface for manipulating the results of speech archive searches;

FIG. 5 illustrates a flowchart of a method for manipulating the results of a media archive search in accordance with exemplary embodiments;

FIG. 6 illustrates a representation of media archive search result items; and

FIG. 7 illustrates another representation of media archive search result items.

### DETAILED DESCRIPTION

Exemplary embodiments include a method and system for enhancing the user interfaces used for searching media archives, enabling media archive searches and precise random access based on the positions of the search terms in the voice stream. The method and system also enable users to remove streams found irrelevant, re-rank media streams in the result set, zoom into certain streams and keep only a fragment of the stream in the final result set, which can be a result of accessing the returned media streams. The method and system can further create new streams from the concatenation of existing streams or stream fragments, annotating both original and new streams and saving the result of these user actions for future access or for sharing it with other users of the media archive.

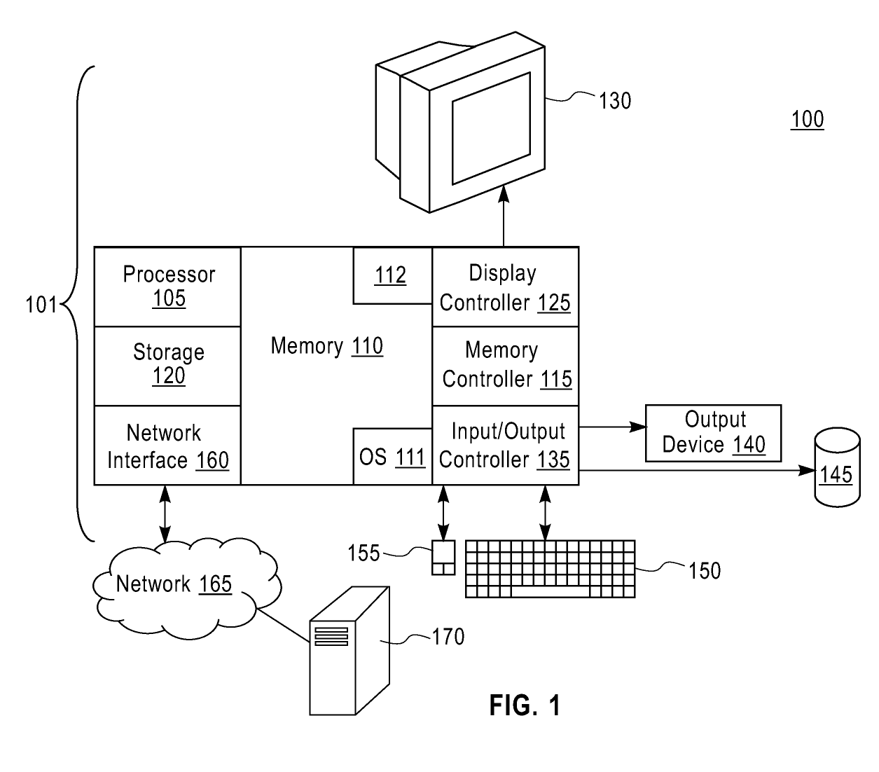

FIG. 1 illustrates a system 100 for manipulating the results of searching media archives. In exemplary embodiments, the system 100, having a media search application 112, is part of a client-server architecture. The client (i.e., the application 112) can be a browser-based application residing on a general purpose computer 101. The server side, which can be in communication with a network 165, is responsible for the interaction with the media archive while the client component implements the user interface. In exemplary embodiments, the application 112 can be distributed over the client side and the server side. For illustrative purposes, the exemplary embodiments described herein are illustrated with respect to the client side. It is appreciated that the methods can be implemented across both the client and server. The server side responsible for interacting with the media archive can be implemented by one or multiple server machines. The client application 112, as a browser-based application, can be retrieved from the local client machine or, more commonly, from a server machine 170, possibly different from the servers performing the searches of the media archive.

In exemplary embodiments, users initiate media searches by providing the search terms used to form the Boolean query, which is sent over the network 165 to the server component for execution. Search results, which include reference to the media streams in the archive, static metadata related to each of the streams (stream title, author, date, length, and annotations), and dynamic metadata (e.g., position(s) of the search terms in the said streams, transcript fragments surrounding search terms) are returned to the client component. Using the values returned by the server and user preferences, the client component constructs the result screen. User preferences determine the order in which the streams are displayed (e.g., by their rank in the result set, increasing/decreasing length, by date, by title or by author), the static metadata that is displayed, and which of the received dynamic metadata elements are displayed and their display format (e.g., if transcript fragment surrounding the search terms are displayed, length of fragments, analyzed used to filter said fragments). User preferences can be static while the best representation of the search results is dependent on the results of the search. Furthermore, transcript errors lead to incorrect relevance ranking, and false positives, which reduce precision, as defined by true positives divided by the sum of true and false positives. In addition, transcript errors often lead to false negatives, which reduce recall, i.e., percentage of relevant items retrieved by the Boolean search. False negatives are likely when the searched terms occur only once or a few times in the recording and all instances of the searched terms are translated incorrectly. To increase recall, users typically make searches more inclusive, which lowers precision. As a result, the search result (or ranked) set is large and users need help in locating the relevant items. In exemplary embodiments, users can dynamically customize the result screen using domain specific information or information collected from listening to fragments of the retrieved streams. The customization enables listening to a series/collection of recordings on a desired topic or for sharing a collection of (one or more) podcasts with colleagues as part of a collaborative activity. Customization of search results includes but it is not limited to: reordering the elements in the result set, extending the result set with stream fragments, removing elements of the result set, setting the visibility of various search terms marking the streams in the results set, and editing the transcript fragments associated with the search terms (e.g., to compensate for the transcriber's inability to identify out-of-the-vocabulary terms, start of a sentence).

The exemplary methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes the general-purpose computer 101. Other embodiments include a software implementation with the client and server components running on the same machine or a monolithic software implementation, with the previously described client and server functionality implemented in one application running on a personal computer.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the media archives search manipulation methods described herein in accordance with exemplary embodiments and a suitable operating system (OS) 111. The operating system 111 essentially controls the execution of other computer programs, such the media archives search manipulation systems and methods described herein, and provides scheduling, input-output control, file and data management, memory management, and communication control and related services.

The media archives search manipulation methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the media archives search manipulation methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The media archives search manipulation methods described herein and the OS 111, in whole or in part, but typically the latter, are read by the processor 105, perhaps buffered within the processor 105, and then executed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the media archives search manipulation methods are implemented in hardware, the media archives search manipulation methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The following figures illustrate screenshots of an exemplary user interface in accordance with exemplary embodiments. The screenshots illustrate examples of user manipulation of media search results.

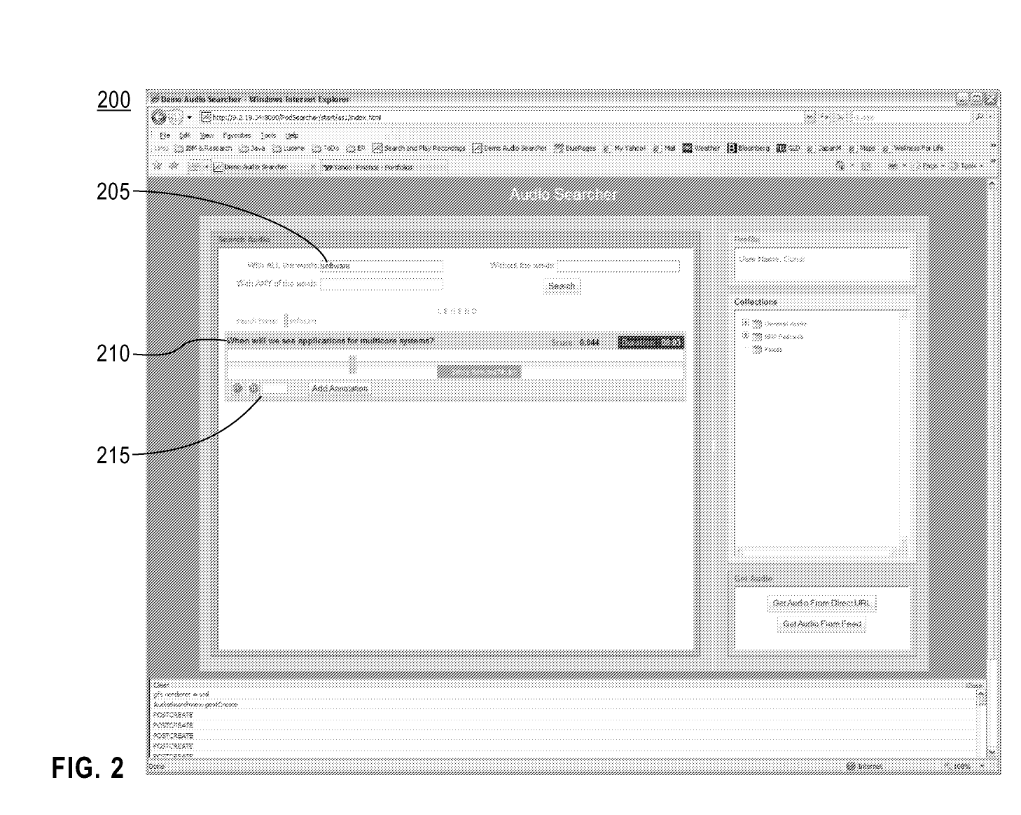

FIG. 2 illustrates a screenshot 200 of an example of a browser-based user interface (UI) for manipulating the results of speech archive searches. In the example, the UI can include a first query field 205, which in the example, includes the word “software”. The first query field is for selecting recordings in the archive that contain all the words in query field 205. In the particular archive being searched, one result is displayed in a first result field 210. The result illustrated is an audio recording “When will we see applications for multicore systems?” The example further illustrates that the search result can further include a score indicating a weight of the search result, which can be based on the number of times the search query word occurs in the result with respect to the total number of words in the result. The UI can further include an Add Annotation field 215, in which the user can manually add annotations to the search.

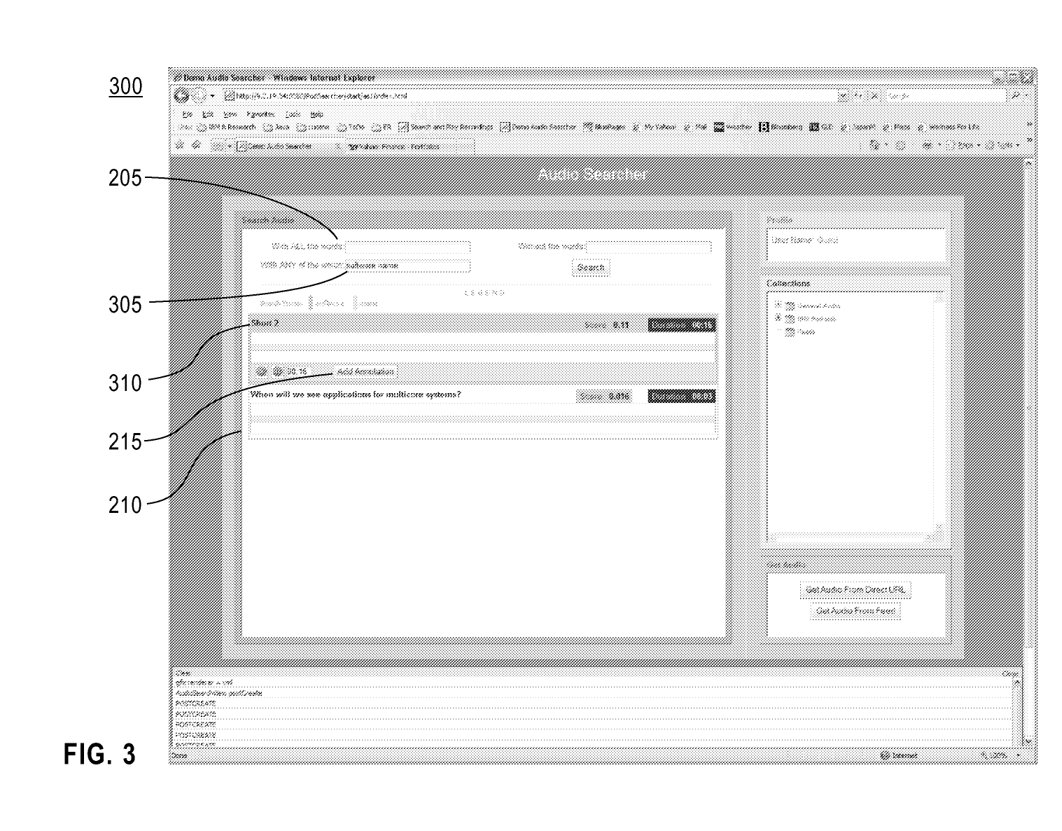

FIG. 3 illustrates a screenshot 300 of an example of a browser-based UI for manipulating the results of speech archive searches, showing a two-recording result set. In this example, the user includes two words in a second query field 305 that provides a query based on any of the words entered. In the example, the words “software” and “name” are used in the query. A two-stream result is illustrated. The result “When will we see applications for multicore systems?” is shown again in the first result field 210, and a result “Short 2” is shown in a second result field 310. Each of the results includes a score. The score for “When will we see applications for multicore systems?” is different than as illustrated in FIG. 2. The difference in the score is a result of different relative weightings of the presence of any of the words that are used in the search query as further described herein.

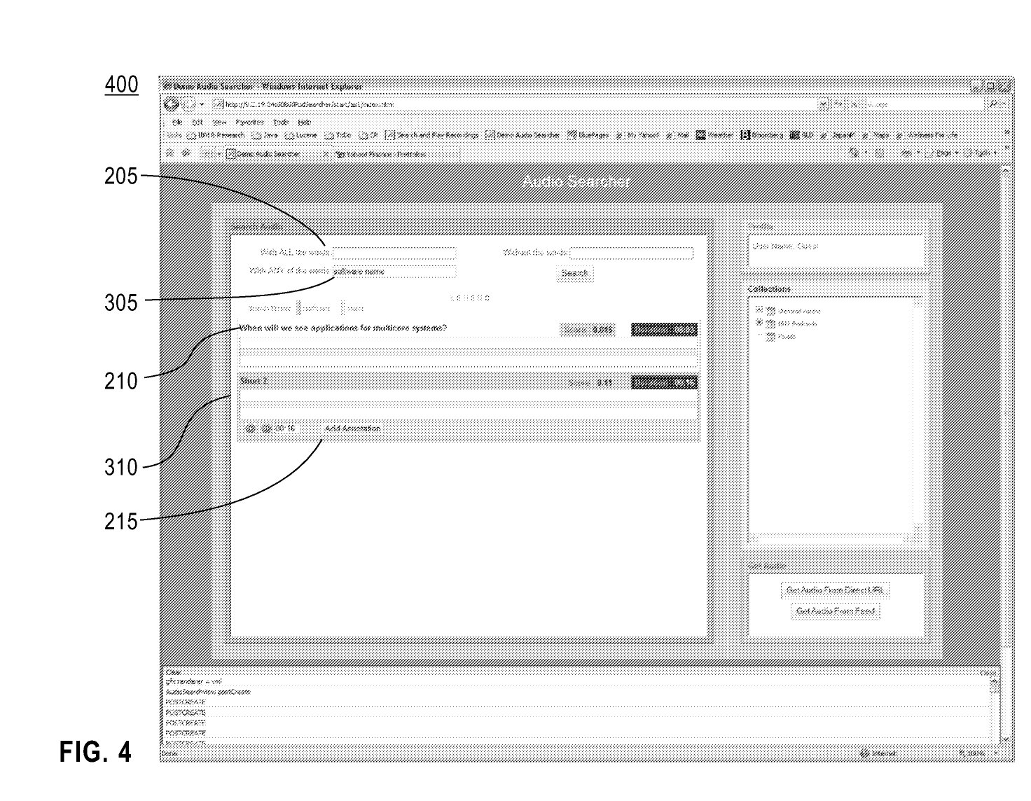

FIG. 4 illustrates a screenshot 400 of an example of a browser-based user interface (UI) for manipulating the results of speech archive searches, after a user manually changes the order of the streams in the result set. This example illustrates that a user can manually change the ordering of the media archive search results as further described herein.

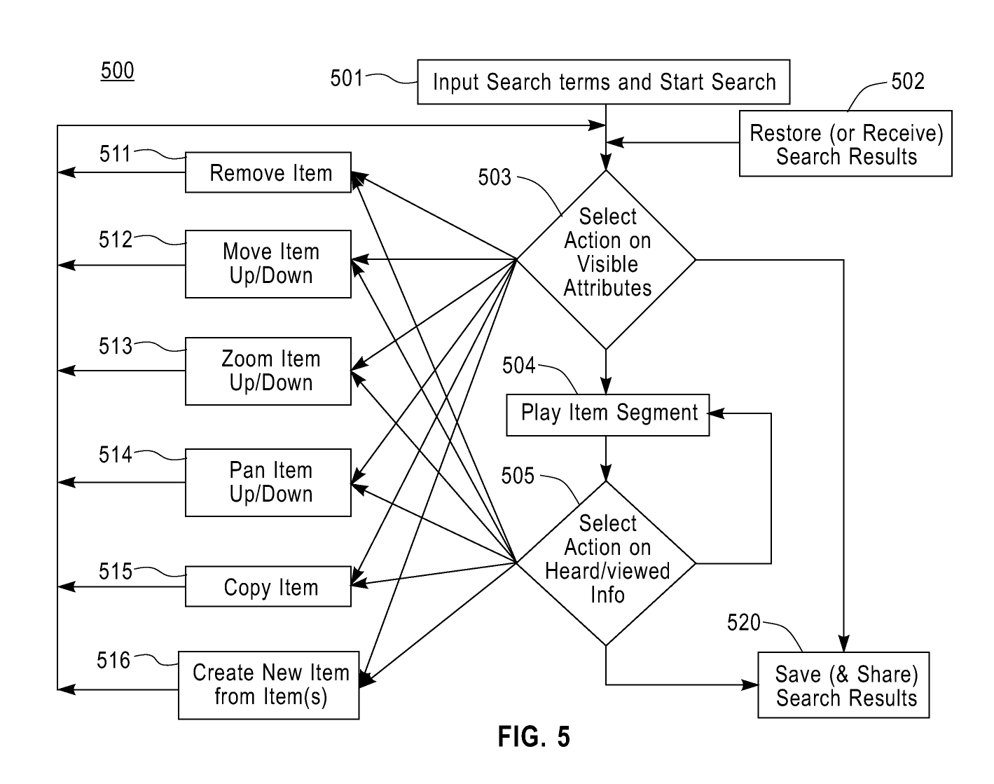

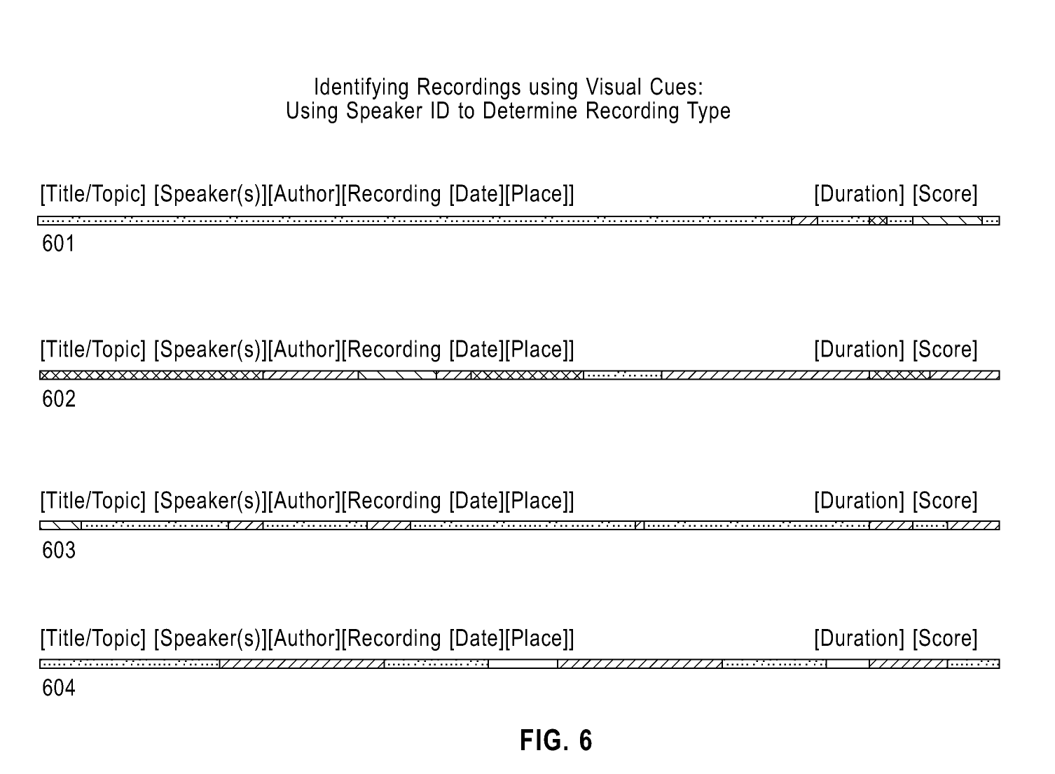

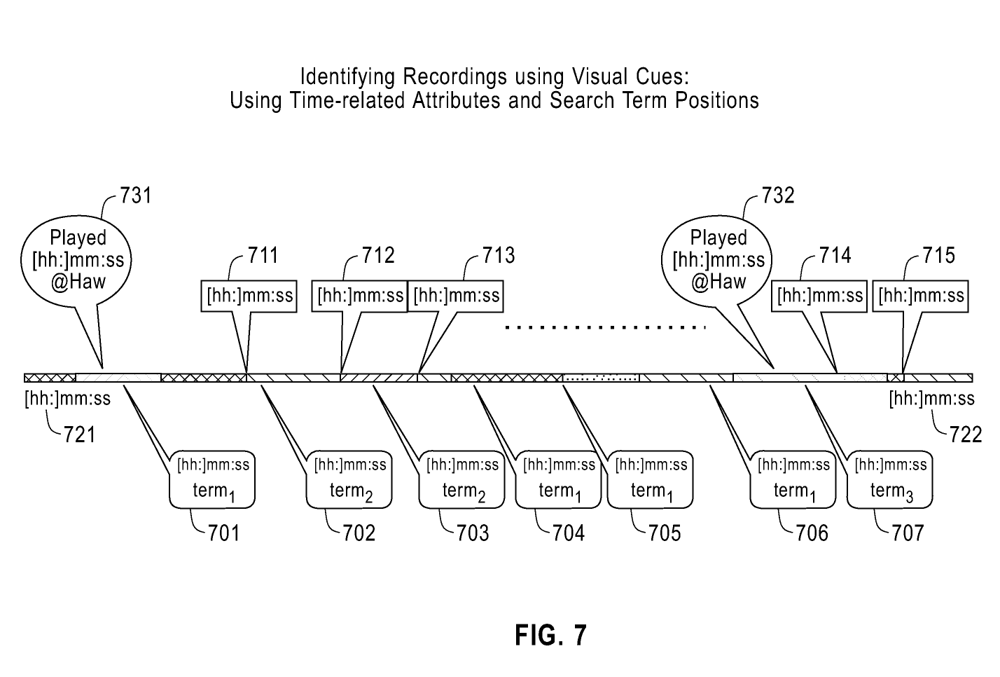

FIG. 5 illustrates a flowchart of a method 500 for manipulating the results of a media archive search in accordance with exemplary embodiments. The method 500 illustrates an example of the sequence of actions the user can perform on the results of a search on a media archive. In exemplary embodiments, these actions can be performed on the results returned by a search tool, which can be a component of the application 112 or a self-contained search tool residing on the computer 101 on the server. As such, at block 501, the search terms can be input and the search started. In exemplary embodiments, the actions can also be performed on a previously edited list of results, where the previous edits were performed by the same user or a colleague/friend/collaborator. As such, at block 502, the search results can be restored or received. An example of such a search result list is shown in FIG. 6, with each horizontal line representing a recording in the media archive that satisfies the Boolean query condition. More details for each recording are shown in FIG. 7 and further described herein.

Referring still to FIG. 5, in exemplary embodiments, the user can select an action at blocks 511-516 to perform by visually inspecting the results on the display 130. The actions can include, but are not limited to removing an item at block 511, moving an item up and down at block 512, zooming an item up or down at block 513, panning an item up or down at block 514, copying an item at block 515 and creating a new item from other items at block 516. In exemplary embodiments, a user can also decide to play a segment of a media recording at block 504 and, based on the result select one of the actions at blocks 511-516, or play an additional segment of one of the media items on the display 130. In exemplary embodiments, the actions at blocks 511-516 can be performed either on the visual attributes on the display 130 at block 503 or on the heard/viewed information at block 505.

In exemplary embodiments, visual inspection takes into consideration a number of attributes of the media items in the result set. Some of the attributes are intrinsic of the media items and are stored in the archive together with the item. Other attributes are specific to the search action and are generated by the media search tool. Another category of attributes is generated by the user actions. Visual attributes are described with respect to FIGS. 6 and 7.

In exemplary embodiments, items that the user considers to be irrelevant can be removed from the result set at block 511. This action allows the user to focus on a smaller set of results. Items can also be reordered at block 512 such that the user can focus on one group at a time or to prioritize play actions. If, for example, only a segment of a media item is deemed interesting, the user can zoom at block 513 and pan at block 514 on the relevant section. If more than one sections of an item are considered interesting, the user can create one or more copies of an item at block 515, followed by different zoom at block 513 and pan at block 514 applied to each copy.

In addition to copying items, the user can create new items by cut & paste operations involving one or more items at block 516. For example, a user can remove uninteresting segments from a media recording, effectively shortening it, or create a longer one from several related recordings. The aforementioned operations are virtual in the sense that no new recordings are generated; instead, each new recording is represented by the tool as a sequence of operations for the embedded media player. In exemplary embodiments, at any time, the user can select to save the modified result list for later or for sharing it with colleagues at block 520.

FIG. 6 illustrates a representation of media archive search result items, which shows several result items. In exemplary embodiments, items can include one or more segments, which can be displayed in different shades of grey or color, with the shade/color of the segment representing the speaker and blanks representing quiet periods, for example. Even when speaker identities are unknown, speech-to-text systems can typically differentiate between speakers. A quick visual inspection can help the user identify the type of media item. This type of identification is very helpful for recordings with which the user is familiar.

In exemplary embodiments, a user can have a pattern in mind, that comes from a previous experience, such as attending the recorded event, or from a description of the event (or its recording) received from someone else. As such, in FIG. 6, the user has a familiarity with the results, and has an idea for the items in which she or he is looking.

As illustrated, a first item 601, from top to bottom, appears to be a presentation by one speaker followed by a Q&A session with three questions/comments from different people in the audience. The second item 602 appears, to the user, to be a meeting with four participants, two of which are more active than the other two, and with one of the two most active participants possibly being the host (as indicated by him/her being the first speaker in the meeting), as indicated by the varying lengths of the shaded segments. The third item 603 looks, to the user, like the recording of an interview, with short questions followed by longer answers and with the host starting and finishing the recordings, possibly with introduction- and conclusion-like sections, respectively. The fourth item 604 is a two-way meeting or phone conversation with two quiet periods, which are more likely to happen in phone conversations and the word ‘two’ in ‘two-way’ comes from a transcription system identifying two speakers. As such, the item 601 appears to be the desired recording than the remaining items. For example, the speaker in item 602 changes too often and unpredictably (not clear if there is one presenter or not). In addition, if item 603 were a presentation than the Qs were asked during the presentation not in the Q&A session. Finally, the item 604 has some quiet periods, which do not occur in a typical presentation and an almost even distribution between two speakers, which does not fit the pattern with which the user is familiar.

In exemplary embodiments, certain attributes, such as recording quality, can be used to infer whether an item is a recording of a phone conversation or not. If a database of speaker speech signatures is available, the speaker ID can be inferred with high probability by the speech-to-text tool(s). Other attributes, such as title, author, recording duration, date and place, may already be included in the recording file(s) (e.g., MP3 file attributes). Other may be added manually to the recording at transcription or indexing time. All these attributes are considered to be intrinsic to the recording. The “Score” attribute is generated by the tool and is dependent on the search terms used and the content of the media archive.

FIG. 7 illustrates a representation of media archive search results. FIG. 7 illustrates additional visual attributes attached to a single media item. In exemplary embodiments, the user can turn off or disable attribute types/classes at any time. The beginnings and ends of the speaker segments 711, 712, 713, 714, 715 in a recording are a type of intrinsic attributes of the recording. The positions of the search terms 701, 702, 703, 704, 705, 706, 707 in an item included in the result set of Boolean query represents an example of search-specific attribute. In addition to the term position, the tool can display the confidence attached by the speech-to-text tool to the specific term in that position. With regard to the confidence, the speech-to-text translation process is probabilistic, in which the system selects the most likely word at each point in the process. “Most likely” is based on a number, a probability, which is computed based on the recorded sound at that point in the transcription and the context, i.e., previous words, which is captured in what's called the language model. Some systems output alternative text translations together with the associated/computed probabilities.

As a result of user zoom and pan operations, the left and right ends of the line may represent moments in the media recording after or before its start or end, respectively. The visual attributes 721, 722 are examples of attributes generated by the user actions. Additional visual attributes 731, 732 are shown as hashed areas mark segments played by the user and are generated by the tool as a result of user actions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for manipulating the results of a media archive search, the method comprising:
sending search terms related to one or more archive items in the media archive;
receiving search results from the media archive;
displaying the search results on a display;
sending manipulation commands;
performing manipulation operations based on the manipulation commands;
displaying modified search results on the screen based on the manipulation operations; and
identifying attributes for each of the one or more archive items.

2. The method as claimed in claim 1 wherein the manipulation operations include at least one of moving the one or more archive items on the display, zooming the one or more archive items on the display, panning the one or more archive items on the display, copying the one or more archive items on the display, and creating a new item from the one or more archive items.

3. The method as claimed in claim 1 further comprising playing a segment of the one or more archive items.

4. The method as claimed in claim 1 wherein the attributes are intrinsic qualities to the one or more archive items.

5. The method as claimed in claim 1 wherein the attributes are specific to a search action based on the search terms and are generated by a search tool.

6. The method as claimed in claim 1 wherein the attributes are generated by user actions.

7. The method as claimed in claim 1 wherein the attributes are visual, wherein each of the one or more archive items can be displayed as segments.

8. The method as claimed in claim 7 wherein the segments are identified by at least one of grey scale and color.

9. The method as claimed in claim 7 wherein the segments are indentified by hash marks.

10. In a computer system having a graphical user interface including a display and a selection device, a method for manipulating the results of a media archive search on the display, the method comprising:
retrieving a set of items in a media search;
displaying the set of items on the display;
receiving a manipulation selection command indicative of the selection device pointing at a selected items of the media search; and
in response to the manipulation selection command, performing a manipulation action at the selected items of the media search.

11. The method as claimed in claim 10 wherein the manipulations action include at least one of moving the one or more archive items on the display, zooming the one or more archive items on the display, panning the one or more archive items on the display, copying the one or more archive items on the display, and creating a new item from the one or more archive items.

12. The method as claimed in claim 10 further comprising:
receiving a play selection signal indicative of the selection device pointing at the one or more archive items on the display; and
in response to the play selection signal playing a segment of the one or more archive items.

13. The method as claimed in claim 10 wherein the attributes are intrinsic qualities to the one or more archive items.

14. The method as claimed in claim 10 wherein the attributes are specific to a search action based on the search terms and are generated by a search tool.

15. The method as claimed in claim 10 wherein the attributes are generated by user actions.

16. The method as claimed in claim 10 wherein the attributes are visual, wherein each of the one or more archive items can be displayed as segments.

17. The method as claimed in claim 16 wherein the segments are identified by at least one of grey scale and color.

18. The method as claimed in claim 16 wherein the segments are indentified by hash marks.

19. A computer program product for manipulating the results of a media archive search, the computer program product including instructions for causing a computer to implement a method, the method comprising:
sending search terms related to one or more media archive items in the media archive;
receiving search results from the media archive;
displaying the search results on the display;
sending manipulation commands;
performing manipulation operations based on the manipulation commands;
displaying modified search results on the screen based on the manipulation operations; and
identifying attributes for each of the one or more archive items.

20. The system as claimed in claim 19 wherein the manipulation operations include at least one of moving the one or more archive items on the display, zooming the one or more archive items on the display, panning the one or more archive items on the display, copying the one or more archive items on the display, and creating a new item from the one or more archive items.
